(19) United States
(12) Patent Application Publication
(10) Pub. No.: US 2011/0131049 A1
(43) Pub. Date: Jun. 2, 2011

(54) Method and Apparatus for Providing a Framework for Efficient Scanning and Session Establishment

(75) Inventor: Sailesh Kumar Sathish, Tampere (FI)

(73) Assignee: NOKIA CORPORATION, Espoo (FI)

(21) Appl. No.: 12/958,121

(22) Filed: Dec. 1, 2010

Related U.S. Application Data
(60) Provisional application No. 61/265,558, filed on Dec. 1, 2009.

(51) Int. Cl. G10L 21/00

(52) U.S. Cl. 704/270; 704/E11.001

(57) ABSTRACT

A method of providing a framework for efficient scanning and session establishment may include receiving vocabulary independent property information indicative of a property request and corresponding setting information of an application associated with a device capable of communication with a network communication environment, determining capabilities of the network communication environment relative to the received property information, and enabling generation of a selected scan function having selected scan parameters based at least in part on the determined capabilities and the property information. A corresponding apparatus and computer program product are also provided.

### CROSS REFERENCE TO RELATED APPLICATION

This application claims the benefit of U.S. Provisional Application No. 61/265,558, filed Dec. 1, 2009, the contents of which are incorporated herein in their entirety.

### TECHNOLOGICAL FIELD

Embodiments of the present invention relate generally to communication interface technology and, more particularly, relate to a method and apparatus for enabling efficient scanning and session establishment such as for establishing a session in a smart space.

### BACKGROUND

The modern communications era has brought about a tremendous expansion of wireline and wireless networks. Computer networks, television networks, and telephony networks are experiencing an unprecedented technological expansion, fueled by consumer demand. Wireless and mobile networking technologies have addressed related consumer demands, while providing more flexibility and immediacy of information transfer.

### BRIEF SUMMARY

A method, apparatus and computer program product are therefore provided for enabling the provision of a framework for efficient scanning and session establishment for devices in environments such as, for example, smart spaces. Accordingly, for example, a session module may be provided that is configured to enhance the ability of devices to indicate their resource requirements in a vocabulary or language that may be understandable to any smart space and may also enable information about the smart space to be provided to a device entering the smart space in an understandable fashion so the entering device may be enabled to scan the environment efficiently for application requirements.

In one exemplary embodiment, a method of providing a framework for efficient scanning and session establishment is provided. The method may include receiving vocabulary independent property information indicative of a property request and corresponding setting information of an application associated with a device capable of communication with a network communication environment, determining capabilities of the network communication environment relative to the received property information, and enabling generation of a selected scan function having selected scan parameters based at least in part on the determined capabilities and the property information.

In another exemplary embodiment, a computer program product for providing a framework for efficient scanning and session establishment is provided. The computer program product includes at least one computer-readable storage medium having computer-executable program code instructions stored therein. The computer-executable program code instructions may include program code instructions for receiving vocabulary independent property information indicative of a property request and corresponding setting information of an application associated with a device capable of communication with a network communication environment, determining capabilities of the network communication environment relative to the received property information, and enabling generation of a selected scan function having selected scan parameters based at least in part on the determined capabilities and the property information.

In another exemplary embodiment, an apparatus for providing a framework for efficient scanning and session establishment is provided. The apparatus may include at least one processor and at least one memory including computer program code. The at least one memory and the computer program code may be configured, with the processor, to cause the apparatus to perform at least receiving vocabulary independent property information indicative of a property request and corresponding setting information of an application associated with a device capable of communication with a network communication environment, determining capabilities of the network communication environment relative to the received property information, and enabling generation of a selected scan function having selected scan parameters based at least in part on the determined capabilities and the property information.

In another exemplary embodiment, an apparatus for providing a framework for efficient scanning and session establishment is provided. The apparatus may include means for receiving vocabulary independent property information indicative of a property request and corresponding setting information of an application associated with a device capable of communication with a network communication environment, means for determining capabilities of the network communication environment relative to the received property information, and means for enabling generation of a selected scan function having selected scan parameters based at least in part on the determined capabilities and the property information.

Some embodiments of the invention may therefore provide a method, apparatus and computer program product that may provide device users with improved capabilities and user experience with respect to using applications and services accessible via the device.

### BRIEF DESCRIPTION OF THE SEVERAL VIEWS OF THE DRAWING(S)

Having thus described embodiments of the invention in general terms, reference will now be made to the accompanying drawings, which are not necessarily drawn to scale, and wherein:

FIG. 1 is a schematic block diagram of a mobile terminal according to an exemplary embodiment of the present invention;

FIG. 2 illustrates a system according to an exemplary embodiment of the present invention;

FIG. 3 is a schematic block diagram of an apparatus for providing a framework for efficient scanning and session establishment according to an exemplary embodiment of the present invention;

FIG. 4 is a block diagram showing various devices and entities with which a session module of an example embodiment may communicate or otherwise interact; and

FIG. 5 is a block diagram according to an exemplary method for enabling the provision of a framework for efficient scanning and session establishment according to an exemplary embodiment of the present invention.

### DETAILED DESCRIPTION

Some embodiments of the present invention will now be described more fully hereinafter with reference to the accompanying drawings, in which some, but not all embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information” and similar terms may be used interchangeably to refer to data capable of being transmitted, received and/or stored in accordance with embodiments of the present invention. Thus, use of any such terms should not be taken to limit the spirit and scope of embodiments of the present invention.

Additionally, as used herein, the term ‘circuitry’ refers to (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device, and/or other computing device.

As defined herein a “computer-readable storage medium,” which refers to a non-transitory physical storage medium (e.g., volatile or non-volatile memory device), can be differentiated from a “computer-readable transmission medium,” which refers to an electromagnetic signal.

Some embodiments of the present invention may be employed to, for example, provide an expanded set of properties (e.g., both remote properties and in-device properties) that may be supported by a set of standard interfaces. Furthermore, embodiments of the present invention may enable the obfuscation or masking of the properties and/or interfaces based on the application accessing device properties. Accordingly, communication may be provided to enable consumers or applications to request certain services such as property initializations, expected data formats, granularity of data, data abstractions, service invocations, and/or the like.

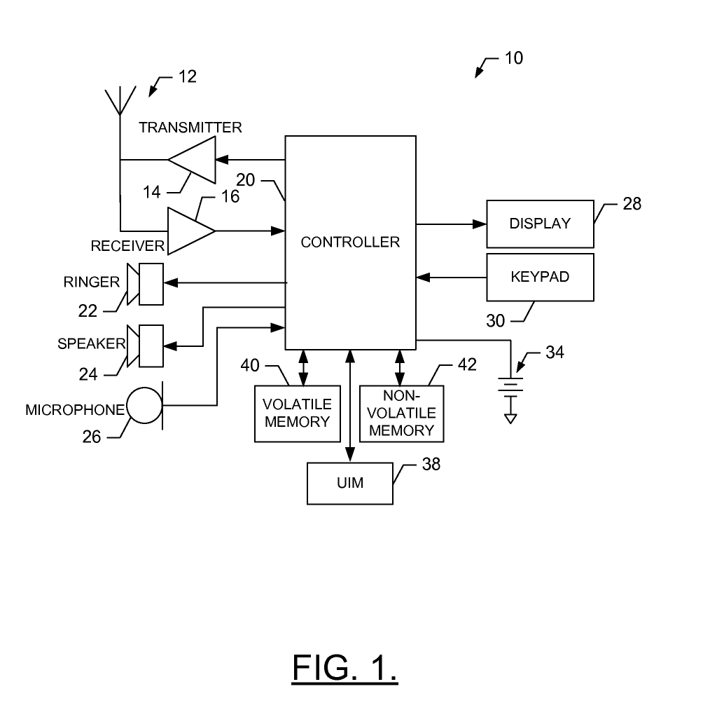

FIG. 1, one exemplary embodiment of the invention, illustrates a block diagram of a mobile terminal 10 that may benefit from embodiments of the present invention. It should be understood, however, that a mobile terminal as illustrated and hereinafter described is merely illustrative of one type of device that may benefit from embodiments of the present invention and, therefore, should not be taken to limit the scope of embodiments of the present invention. While several embodiments of the mobile terminal 10 may be illustrated and hereinafter described for purposes of example, other types of mobile terminals, such as portable digital assistants (PDAs), pagers, mobile televisions, gaming devices, all types of computers (e.g., laptops or mobile computers), cameras, audio/video players, radio, global positioning system (GPS) devices, or any combination of the aforementioned, and other types of communications systems, may readily employ embodiments of the present invention.

The mobile terminal 10 may include an antenna 12 (or multiple antennas) in operable communication with a transmitter 14 and a receiver 16. The mobile terminal 10 may further include an apparatus, such as a controller 20 or other processing element, that provides signals to and receives signals from the transmitter 14 and receiver 16, respectively. The signals may include signaling information in accordance with the air interface standard of the applicable cellular system, and/or may also include data corresponding to user speech, received data and/or user generated data. In this regard, the mobile terminal 10 may be capable of operating with one or more air interface standards, communication protocols, modulation types, and access types. By way of illustration, the mobile terminal 10 may be capable of operating in accordance with any of a number of first, second, third and/or fourth-generation communication protocols or the like. For example, the mobile terminal 10 may be capable of operating in accordance with second-generation (2G) wireless communication protocols IS-136 (time division multiple access (TDMA)), GSM (global system for mobile communication), and IS-95 (code division multiple access (CDMA)), or with third-generation (3G) wireless communication protocols, such as Universal Mobile Telecommunications System (UMTS), CDMA2000, wideband CDMA (WCDMA) and time division-synchronous CDMA (TD-SCDMA), with 3.9G wireless communication protocol such as E-UTRAN (evolved—universal terrestrial radio access network), with fourth-generation (4G) wireless communication protocols or the like. As an alternative (or additionally), the mobile terminal 10 may be capable of operating in accordance with non-cellular communication mechanisms. For example, the mobile terminal 10 may be capable of communication in a wireless local area network (WLAN) or other communication networks.

It is understood that the apparatus, such as the controller 20, may include circuitry implementing, among others, audio and logic functions of the mobile terminal 10. For example, the controller 20 may comprise a digital signal processor device, a microprocessor device, and various analog to digital converters, digital to analog converters, and/or other support circuits. Control and signal processing functions of the mobile terminal 10 are allocated between these devices according to their respective capabilities. The controller 20 thus may also include the functionality to convolutionally encode and interleave message and data prior to modulation and transmission. The controller 20 may additionally include an internal voice coder, and may include an internal data modem. Further, the controller 20 may include functionality to operate one or more software programs, which may be stored in memory. For example, the controller 20 may be capable of operating a connectivity program, such as a conventional Web browser. The connectivity program may then allow the mobile terminal 10 to transmit and receive Web content, such as location-based content and/or other web page content, according to a Wireless Application Protocol (WAP), Hypertext Transfer Protocol (HTTP) and/or the like, for example.

The mobile terminal 10 may also comprise a user interface including an output device such as an earphone or speaker 24, a ringer 22, a microphone 26, a display 28, and a user input interface, which may be coupled to the controller 20. The user input interface, which allows the mobile terminal 10 to receive data, may include any of a number of devices allowing the mobile terminal 10 to receive data, such as a keypad 30, a touch display (not shown), a microphone or other input device. In embodiments including the keypad 30, the keypad 30 may include numeric (0-9) and related keys (#, *), and other hard and soft keys used for operating the mobile terminal 10. Alternatively, the keypad 30 may include a conventional QWERTY keypad arrangement. The keypad 30 may also include various soft keys with associated functions. In addition, or alternatively, the mobile terminal 10 may include an interface device such as a joystick or other user input interface. The mobile terminal 10 further includes a battery 34, such as a vibrating battery pack, for powering various circuits that are used to operate the mobile terminal 10, as well as optionally providing mechanical vibration as a detectable output.

The mobile terminal 10 may further include a user identity module (UIM) 38, which may generically be referred to as a smart card. The UIM 38 is typically a memory device having a processor built in. The UIM 38 may include, for example, a subscriber identity module (SIM), a universal integrated circuit card (UICC), a universal subscriber identity module (USIM), a removable user identity module (R-UIM), or any other smart card. The UIM 38 typically stores information elements related to a mobile subscriber. In addition to the UIM 38, the mobile terminal 10 may be equipped with memory. For example, the mobile terminal 10 may include volatile memory 40, such as volatile Random Access Memory (RAM) including a cache area for the temporary storage of data. The mobile terminal 10 may also include other non-volatile memory 42, which may be embedded and/or may be removable. The non-volatile memory 42 may additionally or alternatively comprise an electrically erasable programmable read only memory (EEPROM), flash memory or the like. The memories may store any of a number of pieces of information, and data, used by the mobile terminal 10 to implement the functions of the mobile terminal 10.

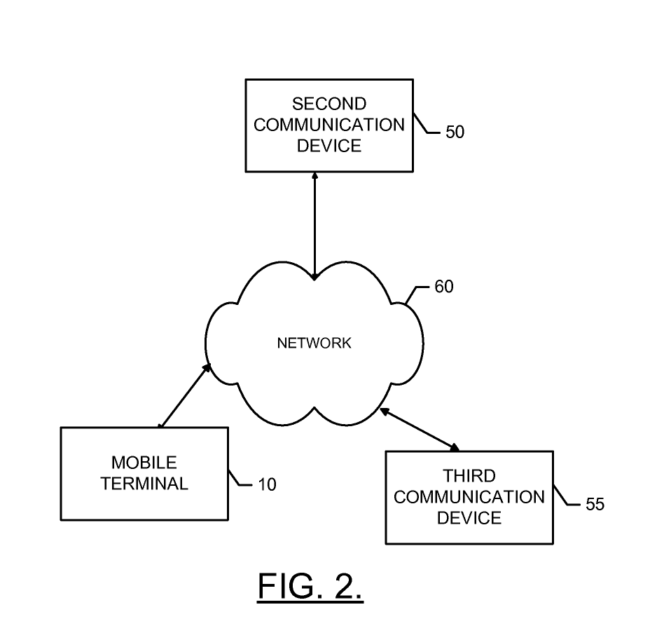

In an exemplary embodiment, the mobile terminal 10 of FIG. 1 may enter a location associated with a smart space and may wish to enter or otherwise establish communication with the smart space. FIG. 2 illustrates a generic system diagram in which a device such as a mobile terminal 10 is shown in an example communication environment that could be or include a smart space. As shown in FIG. 1, an embodiment of a system in accordance with an example embodiment of the present invention may include a first communication device (e.g., mobile terminal 10) and a second communication device 50 capable of communication with each other via a network 60. In some cases, embodiments of the present invention may further include one or more additional communication devices, one of which is depicted in FIG. 2 as a third communication device 55. In some embodiments, not all systems that employ embodiments of the present invention may comprise all the devices illustrated and/or described herein. While several embodiments of the mobile terminal 10 and/or second and third communication devices 50 and 55 may be illustrated and hereinafter described for purposes of example, other types of terminals, such as PDAs, pagers, mobile televisions, mobile telephones, gaming devices, laptop computers, cameras, video recorders, audio/video players, radios, global positioning system (GPS) devices, or any combination of the aforementioned, and other types of voice and text communications systems, can readily employ embodiments of the present invention. Furthermore, devices that are not mobile, such as servers and personal computers may also readily employ embodiments of the present invention.

The network 60 may include a collection of various different nodes (of which the second and third communication devices 50 and 55 may be examples), devices or functions that may be in communication with each other via corresponding wired and/or wireless interfaces. As such, the illustration of FIG. 1 should be understood to be an example of a broad view of certain elements of the system and not an all inclusive or detailed view of the system or the network 60. Although not necessary, in some embodiments, the network 60 may be capable of supporting communication in accordance with any one or more of a number of First-Generation (1G), Second-Generation (2G), 2.5G, Third-Generation (3G), 3.5G, 3.9G, Fourth-Generation (4G) mobile communication protocols, Long Term Evolution (LTE), and/or the like. In some embodiments, the network 60 may be a P2P network.

One or more communication terminals such as the mobile terminal 10 and the second and third communication devices 50 and 55 may be in communication with each other via the network 60 and each may include an antenna or antennas for transmitting signals to and for receiving signals from a base site, which could be, for example a base station that is a part of one or more cellular or mobile networks or an access point that may be coupled to a data network, such as a Local Area Network (LAN), a Metropolitan Area Network (MAN), and/or a Wide Area Network (WAN), such as the Internet. In turn, other devices such as processing elements (e.g., personal computers, server computers or the like) may be coupled to the mobile terminal 10 and the second and third communication devices 50 and 55 via the network 60. By directly or indirectly connecting the mobile terminal 10 and the second and third communication devices 50 and 55 (and/or other devices) to the network 60, the mobile terminal 10 and the second and third communication devices 50 and 55 may be enabled to communicate with the other devices or each other, for example, according to numerous communication protocols including Hypertext Transfer Protocol (HTTP) and/or the like, to thereby carry out various communication or other functions of the mobile terminal 10 and the second and third communication devices 50 and 55, respectively.

Furthermore, although not shown in FIG. 1, the mobile terminal 10 and the second and third communication devices 50 and 55 may communicate in accordance with, for example, radio frequency (RF), Bluetooth (BT), Infrared (IR) or any of a number of different wireline or wireless communication techniques, including LAN, Wireless LAN (WLAN), Worldwide Interoperability for Microwave Access (WiMAX), WiFi, Ultra-Wide Band (UWB), Wibree techniques and/or the like. As such, the mobile terminal 10 and the second and third communication devices 50 and 55 may be enabled to communicate with the network 60 and each other by any of numerous different access mechanisms. For example, mobile access mechanisms such as Wideband Code Division Multiple Access (W-CDMA), CDMA2000, Global System for Mobile communications (GSM), General Packet Radio Service (GPRS) and/or the like may be supported as well as wireless access mechanisms such as WLAN, WiMAX, and/or the like and fixed access mechanisms such as Digital Subscriber Line (DSL), cable modems, Ethernet and/or the like.

In an example embodiment, the network 60 may be an ad hoc or distributed network arranged to be a smart space. Thus, devices may enter and/or leave the network 60 and the devices of the network 60 may be capable of adjusting operations based on the entrance and/or exit of other devices to account for the addition or subtraction of respective devices or nodes and their corresponding capabilities. In an example embodiment, one or more of the devices in communication with the network 60 may employ a context model to assist in providing an interface between applications (e.g., web applications running on the mobile terminal 10 and acting as consumers) and providers (e.g., data providers in the form of network nodes such as the second and/or third communication devices 50 and 55). As such, for example, a consumer application may request information from a provider within the network 60 and any one of the mobile terminal 10 or the second and third communication devices 50 and 55 may host a consumer application while any other one of the mobile terminal 10 or the second and third communication devices 50 and 55 acts as a provider with respect to the consumer application to provide information such as context information to the respective consumer application. The context model may be an object based model in which each provider has an object representation in the model. Thus, the context model may provide consumer applications with access to context data that may include, for example, static and dynamic data descriptive of respective provider capabilities.

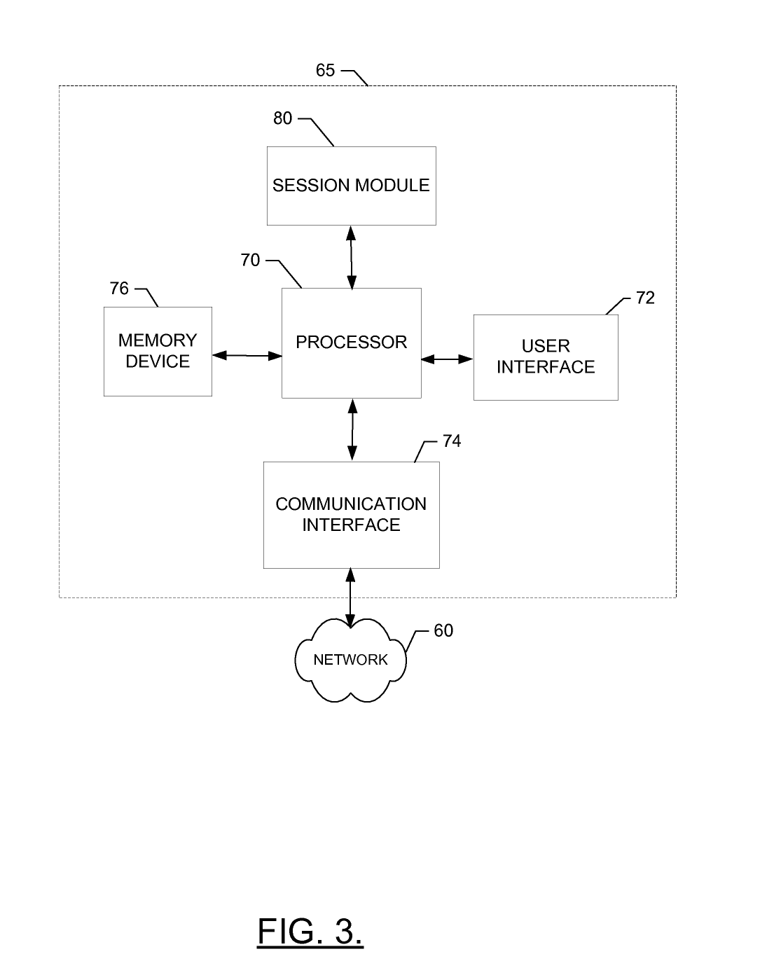

FIG. 3 illustrates a schematic block diagram of an apparatus for enabling the provision of a framework for efficient scanning and session establishment according to an example embodiment of the present invention. An example embodiment of the invention will now be described with reference to FIG. 3, in which certain elements of an apparatus 65 for providing a framework for efficient scanning and session establishment are displayed. The apparatus 65 of FIG. 3 may be employed, for example, on the mobile terminal 10 (and/or the second communication device 50 or the third communication device 55). Alternatively, the apparatus 65 may be embodied on a network device of the network 60. However, the apparatus 65 may alternatively be embodied at a variety of other devices, both mobile and fixed (such as, for example, any of the devices listed above). In some cases, embodiments may be employed on a combination of devices. Accordingly, some embodiments of the present invention may be embodied wholly at a single device (e.g., the mobile terminal 10), by a plurality of devices in a distributed fashion (e.g., on one or a plurality of devices in a P2P network) or by devices in a client/server relationship. Furthermore, it should be noted that the devices or elements described below may not be mandatory and thus some may be omitted in certain embodiments.

Referring now to FIG. 3, an apparatus 65 for providing a framework efficient scanning and session establishment is provided. The apparatus 65 may include or otherwise be in communication with a processor 70, a user interface 72, a communication interface 74 and a memory device 76. The memory device 76 may include, for example, one or more volatile and/or non-volatile memories. In other words, for example, the memory device 76 may be an electronic storage device (e.g., a computer readable storage medium) comprising gates configured to store data (e.g., bits) that may be retrievable by a machine (e.g., a computing device). The memory device 76 may be configured to store information, data, applications, instructions or the like for enabling the apparatus to carry out various functions in accordance with example embodiments of the present invention. For example, the memory device 76 could be configured to buffer input data for processing by the processor 70. Additionally or alternatively, the memory device 76 could be configured to store instructions for execution by the processor 70.

The processor 70 may be embodied in a number of different ways. For example, the processor 70 may be embodied as one or more of various processing means such as a coprocessor, a microprocessor, a controller, a digital signal processor (DSP), a processing element with or without an accompanying DSP, or various other processing devices including integrated circuits such as, for example, an ASIC (application specific integrated circuit), an FPGA (field programmable gate array), a microcontroller unit (MCU), a hardware accelerator, a special-purpose computer chip, processing circuitry, or the like. In an example embodiment, the processor 70 may be configured to execute instructions stored in the memory device 76 or otherwise accessible to the processor 70. Alternatively or additionally, the processor 70 may be configured to execute hard coded functionality. As such, whether configured by hardware or software methods, or by a combination thereof, the processor 70 may represent an entity (e.g., physically embodied in circuitry) capable of performing operations according to embodiments of the present invention while configured accordingly. Thus, for example, when the processor 70 is embodied as an ASIC, FPGA or the like, the processor 70 may be specifically configured hardware for conducting the operations described herein. Alternatively, as another example, when the processor 70 is embodied as an executor of software instructions, the instructions may specifically configure the processor 70 to perform the algorithms and/or operations described herein when the instructions are executed. However, in some cases, the processor 70 may be a processor of a specific device (e.g., a mobile terminal or network device) adapted for employing embodiments of the present invention by further configuration of the processor 70 by instructions for performing the algorithms and/or operations described herein. The processor 70 may include, among other things, a clock, an arithmetic logic unit (ALU) and logic gates configured to support operation of the processor 70.

Meanwhile, the communication interface 74 may be any means such as a device or circuitry embodied in either hardware, software, or a combination of hardware and software that is configured to receive and/or transmit data from/to a network and/or any other device or module in communication with the apparatus. In this regard, the communication interface 74 may include, for example, an antenna (or multiple antennas) and supporting hardware and/or software for enabling communications with a wireless communication network. In some environments, the communication interface 74 may alternatively or also support wired communication. As such, for example, the communication interface 74 may include a communication modem and/or other hardware/software for supporting communication via cable, digital subscriber line (DSL), universal serial bus (USB) or other mechanisms.

The user interface 72 may be in communication with the processor 70 to receive an indication of a user input at the user interface 72 and/or to provide an audible, visual, mechanical or other output to the user. As such, the user interface 72 may include, for example, a keyboard, a mouse, a joystick, a display, a touch screen, soft keys, a microphone, a speaker, or other input/output mechanisms. In an example embodiment in which the apparatus is embodied as a server or some other network devices, the user interface 72 may be limited, or eliminated. However, in an embodiment in which the apparatus is embodied as a communication device (e.g., the mobile terminal 10), the user interface 72 may include, among other devices or elements, any or all of a speaker, a microphone, a display, and a keyboard or the like. In this regard, for example, the processor 70 may comprise user interface circuitry configured to control at least some functions of one or more elements of the user interface, such as, for example, a speaker, ringer, microphone, display, and/or the like. The processor 70 and/or user interface circuitry comprising the processor 70 may be configured to control one or more functions of one or more elements of the user interface through computer program instructions (e.g., software and/or firmware) stored on a memory accessible to the processor 70 (e.g., memory device 76, and/or the like).

In an example embodiment, the processor 70 may be embodied as, include or otherwise control a session module 80. The session module 80 may be any means such as a device or circuitry operating in accordance with software or otherwise embodied in hardware or a combination of hardware and software (e.g., processor 70 operating under software control, the processor 70 embodied as an ASIC or FPGA specifically configured to perform the operations described herein, or a combination thereof) thereby configuring the device or circuitry to perform the corresponding functions of the session module 80 as described below. Thus, in examples in which software is employed, a device or circuitry (e.g., the processor 70 in one example) executing the software forms the structure associated with such means. In this regard, for example, the session module 80 may be configured to provide, among other things, for the provision of a mechanism by which to receive information on application requirements (or requests) with respect to properties or resources and a mechanism by which to scan an environment via dynamically determined scan properties.

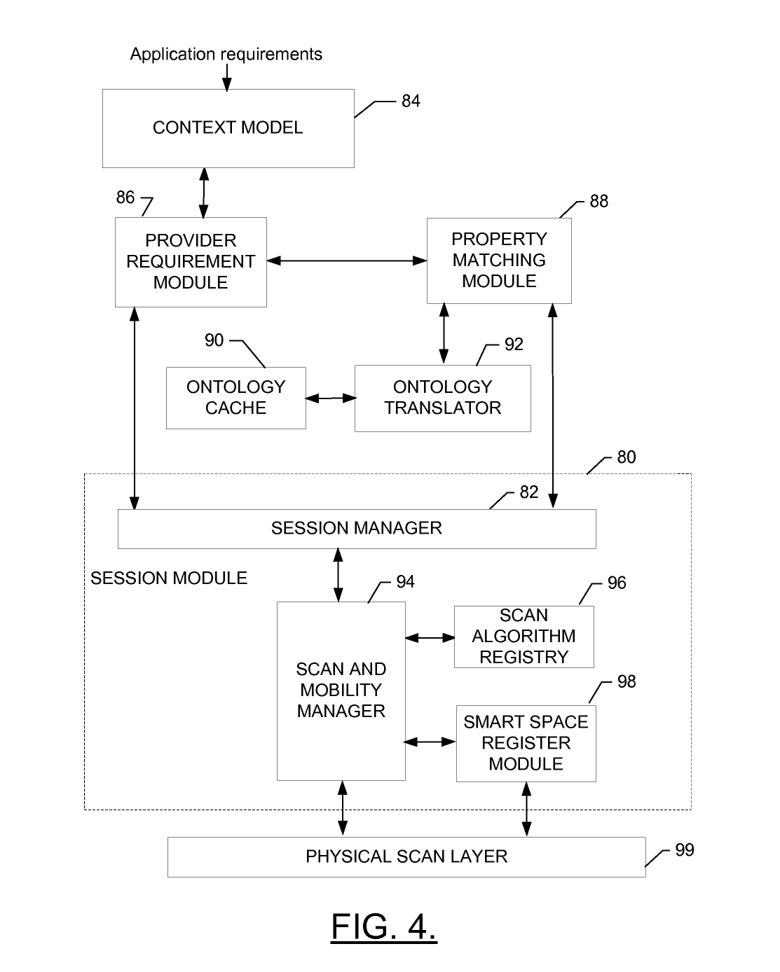

In an example embodiment, the session module 80 may interface with various other devices or entities that may also be embodied at the apparatus 65 or may otherwise be in communication with the apparatus. Some examples of devices and entities with which the session module 80 may communicate or otherwise interact are shown in FIG. 4. However, it should be noted that some embodiments may include more or less than the devices and entities shown in FIG. 4.

Referring now to FIG. 4, the apparatus 65 may further include or communicate with a context model 84, a provider requirement module 86, a property matching module 88, an ontology cache 90 and an ontology translator 92. The ontology cache 90 may be a memory device configured to store information regarding one or more ontologies. In this regard, for example, the ontology cache 90 may store information relating to the vocabulary employed by each respective one of the one or more ontologies.

In an example embodiment, the context model 84 provides a model representation of objects so that information regarding context of the various objects may be provided to calling applications. As such, the context model 84 may be configured to utilize representations of properties to define a context model so that, for example, web applications may be enabled to access context information to perform self adaptation and customization. The context model 84 may support numerous types of topologies such as, for example, tree based hierarchical topologies, single backbone based topologies and/or mixed backbone-tree based topologies. The context model 84 may be a modularized model of various properties associated with respective providers. Accordingly, consumers (e.g., applications including browser applications or web applications) may reference the context model 84 for context information regarding providers in order to perform self adaptations and customizations.

In an example embodiment, the context model 84 may be configured to receive an application requirement or request from an application. The application requirement may indicate the properties or resources that the application needs or desires as property information. For example, the property information may indicate the properties the application intends to use when connected to the network 60 or a smart space associated with the network 60. Each property may also have specific settings associated therewith. In an example embodiment, application requirements may be provided through scripts associated with a web page by calling the corresponding interfaces in the context model 84. The property information, comprising information indicative of the requested properties and associated settings that is received via the context model 84, may then be passed along to the provider requirement module 86. In some embodiments, the property information may include namespace and name of ontology for properties to which an application refers, and a propertyRequirement nodeList (e.g., a DOMNodeList), information indicative of a property requirement node (e.g., name of property, namespace, required functions, namespace to functions, required refresh rate for event notifications in milliseconds, scan range, and others). The session module 80 may then provide (e.g., via operation in conjunction with the scan and mobility manager 94 described below) for effective communication and management with respect to remote properties.

The provider requirement module 86 may be configured to store the property information received from the context model 84. Thus, for example, the provider requirement module 86 may include memory space to enable the storage of the property information received. The property information received may include among other things, for example, information indicative of the intended rate of usage and associated initialization and/or settings information for provider properties that the application desires or requires. In some embodiments, the ontology cache 90 and/or the provider requirement module 86 may be a portion of the memory device 76. However, in other embodiments, the ontology cache 90 and/or the provider requirement module 86 may be embodied at another storage device.

Stored property information from the provider requirement module 86 may then be provided to the property matching module 88 as the ontology translator 92 is consulted in order to translate between the ontology of the smart space or network 60 and the ontology of the local device context framework associated with the application providing the property information. In this regard, translation may be needed due to the fact that various applications and smart spaces may have their own specific vocabularies associated therewith. The fact that different smart spaces may employ different vocabularies or languages is, in fact, a motivation for providing some embodiments of the present invention. The different vocabularies may make it difficult for a device to move seamlessly between different smart spaces, since each smart space could employ a different vocabulary for defining properties and settings. The ontology cache 90 may store ontological information descriptive of various different vocabularies that may be encountered. In an example embodiment, the ontology translator 92 may be configured to provide information enabling translation between different ontologies or vocabularies. Accordingly, the vocabularies that may be employed by different local device context frameworks and various different smart spaces may be tied together via ontological translation and the property matching module 88 may be configured to match property information provided from the local device context framework to available properties. In other words, the property matching module 88 may be configured to match properties requested to available properties within the smart space based on ontological translation. Thus, for example, if the property requirement module 86 stores property information descriptive of properties requested by an application, the property matching module 88 may utilize the ontology translator 92 to identify matching properties in the language of the smart space to be entered.

Once properties are matched and identified, the provider requirement module 86 and the property matching module 88 may communicate with the session module 80 to pass the data structures for consumer requirements and initialization. In other words, the provider requirement module 86 and the property matching module 88 may communicate with the session manager 80 to enable the session manager 80 to be made aware of the requested properties in the vocabulary of the smart space to be entered so that the session module 80 may ultimately interface with the smart space to be entered in a vocabulary that is understandable to the smart space to be entered. Thus, the session module 80 may initially be made aware of the properties requested by a particular application that may interface with a smart space. However, the session module 80 may further be made aware of the properties requested corresponding matching properties available according to the ontology employed by the smart space being entered. As will be seen below, the session module 80 may use this information in order to scan the smart space environment in an efficient way based on the information gathered about the smart space.

In an example embodiment, the session module 80 may include a session manager 82, a scan and mobility manager 94, a scan algorithm registry 96 and a smart space register module 98. The session manager 82, the property matching module 88, the ontology translator 92, the scan and mobility manager 94, the scan algorithm registry 96 and the smart space register module 98 may each be any means such as a device or circuitry operating in accordance with software or otherwise embodied in hardware or a combination of hardware and software (e.g., processor 70 operating under software control, the processor 70 embodied as an ASIC or FPGA specifically configured to perform the operations described herein, or a combination thereof) thereby configuring the device or circuitry to perform the corresponding functions of the session manager 82, the property matching module 88, the ontology translator 92, the scan and mobility manager 94, the scan algorithm registry 96 and the smart space register module 98, respectively, as described herein.

In an exemplary embodiment, the smart space register module 98 may be configured to collect information about particular smart space environments. However, in some instances, the smart space register module 98 may include pre-provided information about one or more smart spaces, which may be provided by the original equipment manufacturer or a particular software vender. In some cases, the smart space register module 98 may discover information about particular smart space environments via a physical scan layer 99. However, in some alternative cases, the scan and mobility manager 94 may collect this information via the physical scan layer 99. The smart space provides information about itself to a device, provided the smart space has such capabilities, when the device (e.g., a device associated with the apparatus 65) scans for a contact point within the network 60 associated with the smart space. In a typical situation, the information provided to the smart space register module 98 may include information indicative of the devices and services available via the smart space (in some cases including a corresponding description of the devices and/or services, an indication of the static or dynamic nature of the devices and services, etc.). The information provided may also include information about the physical range of the smart space and/or any applicable boundaries, and/or information regarding the location of static devices with respect to a central smart space coordinate system and the location of the current user device. In an example embodiment, the information provided may also include information descriptive of the ontology supported by the particular smart space.

The information about a particular smart space environment may be obtained by the smart space register module 98 directly via communication with the smart space over a physical medium in some cases. However, in some cases, name, namespace and location of smart space may be provided to the smart space register module 98 of a local device and, for example, the session manager 82 may utilize the Internet to look up or otherwise fetch descriptions of the corresponding smart space and provide information to the smart space register module 98. In some embodiments, a basic scan may be performed by the local device in order to determine boundaries of a smart space.

The scan algorithm registry 96 may be configured to include a list of scan functions that can be chosen based on current context and smart space configuration. For example, in some cases, a scan function may be a sine wave or some other specific scan wave. Thus, for example, the scan algorithm registry 96 may indicate that the sine wave is a selectable option as a scan function. The scan and mobility manager 94 may then use the provided information to select a scan function (e.g., the sine wave) and apply selected parameters (e.g., amplitude and frequency) to the selected scan function to determine a scan model for implementation with the physical scan layer 99. The scan function selected with the corresponding selected parameters may then be applied to the smart space as a selected scan algorithm. In other words, the session module 80 may employ the session manager 82, the scan algorithm registry 96, the scan and mobility manager 94 and the smart space register module 98 to determine a scan function and corresponding parameters that are tailored to the smart space being entered. The scan function and corresponding parameters may then be used to modulate the physical scan layer 99 with the selected scan algorithm. When employed, the amplitude may determine the range of the physical scan while the frequency determines the timing employed by each scan. The amplitude and frequency employed (as example parameters) itself may be variable and be dependent on context such as temporal or spatial parameters and application requirements that may vary. As such, the scan function and parameters defining the scan algorithm to be employed for scanning a smart space may be determined dynamically based at least in part on device context information associated with the user's device.

In an example embodiment, the scan and mobility manager 94 may be configured to track user location and proximity to nearby services and other devices to utilize such information for changing amplitude accordingly. Thus, by changing the amplitude, the range may be limited when services are nearby and extended range is not needed to contact services that satisfy property requests provided by a consumer application. Accordingly, some embodiments of the present invention may provide for variability with respect to scan functions and parameters employed both in spatial and temporal dimensions within a smart space. As such, a scan methodology employed by a device may be altered to correspond to the context of the device in a manner that may provide savings in terms of power consumption and computation, while still providing customized service provision to users in an efficient manner.

Accordingly, some embodiments of the present invention may provide a mechanism by which to inform the session module 80 of property information including settings that are requested in association with a property requirement from a particular application (e.g., via the provider requirement module 86) and to do so in a vocabulary independent fashion since the properties available in a particular smart space may be matched to the requested property information (e.g., via the property matching module 88). Having an understanding of the capabilities of the particular smart space and the context of the user's device along with the consumer application property information, the session module 80 may thereafter generate scan functions and parameters tailored to the current situation. As such, the session module 80 may be enabled to determine how services are formulated, how data transfer is done, and how scan area and frequencies are determined in order to provide efficient and dynamically determined scan function and parameters for obtaining services in smart environments where user mobility and context may be considered. Moreover, the session module 80 may be configured to select a particular scan technology based on current requirements weighing different options such as bandwidth, range, power, etc. In some examples, the session module 80 may select between Bluetooth, WLAN or another technology to scan a particular environment based on current requirements.

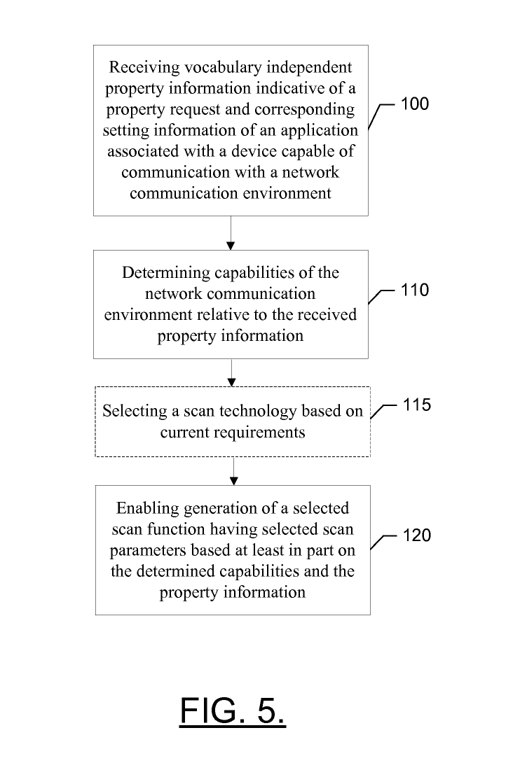

FIG. 5 is a flowchart of a method and program product according to example embodiments of the invention. It will be understood that each block or step of the flowchart, and combinations of blocks in the flowchart, may be implemented by various means, such as hardware, firmware, processor, circuitry and/or other device associated with execution of software including one or more computer program instructions. For example, one or more of the procedures described above may be embodied by computer program instructions. In this regard, the computer program instructions which embody the procedures described above may be stored by a memory device of the mobile terminal or network device and executed by a processor in the mobile terminal or network device. As will be appreciated, any such computer program instructions may be loaded onto a computer or other programmable apparatus (e.g., hardware) to produce a machine, such that the instructions which execute on the computer or other programmable apparatus create means for implementing the functions specified in the flowchart block(s). These computer program instructions may also be stored in a computer-readable memory that may direct a computer or other programmable apparatus to function in a particular manner, such that the instructions stored in the computer-readable memory produce an article of manufacture including instruction means which implement the function specified in the flowchart block(s). The computer program instructions may also be loaded onto a computer or other programmable apparatus to cause a series of operations to be performed on the computer or other programmable apparatus to produce a computer-implemented process such that the instructions which execute on the computer or other programmable apparatus implement the functions specified in the flowchart block(s).

Accordingly, blocks of the flowchart support combinations of means for performing the specified functions, combinations of operations for performing the specified functions and program instruction means for performing the specified functions. It will also be understood that one or more blocks of the flowchart, and combinations of blocks in the flowchart, can be implemented by special purpose hardware-based computer systems which perform the specified functions, or combinations of special purpose hardware and computer instructions.

In this regard, a method according to one embodiment of the invention, as shown in FIG. 5, includes receiving vocabulary independent property information indicative of a property request and corresponding setting information of an application associated with a device capable of communication with a network communication environment at operation 100 and determining capabilities of the network communication environment relative to the received property information at operation 110. The method may further include enabling generation of a selected scan function having selected scan parameters based at least in part on the determined capabilities and the property information at operation 120.

In some embodiments, certain ones of the operations above may be modified or further amplified as described below. Moreover, in some cases additional optional operations may be added to augment the method above (an example of which is shown in dashed lines in FIG. 5). It should be appreciated that each of the modifications, augmentations or amplifications below may be included with the operations above either alone or in combination with any others among the features described herein. In some example cases, the method may further include selecting a particular scan technology at operation 115. As indicated above, the selection of a particular scan technology may be made based on current requirements weighing various options.

In an example embodiment, enabling generation of the selected scan function includes selecting a scan wave from a list of scan functions and applying scan parameters including a selectable frequency value or a selectable amplitude value to the selected scan wave. Moreover, in some cases, enabling generation of the selected scan function further includes selecting the amplitude value based on proximity of the device with respect to range or boundary information associated with the network communication environment. In some embodiments, the network communication environment may be a smart space. In some embodiments, determining capabilities of the network communication environment includes providing a translation between vocabulary associated with describing the property information by the device and a vocabulary associated with an ontology employed by the network communication environment for describing available properties. Additionally or alternatively, in an example embodiment, determining capabilities of the network communication environment include determining characteristics of a smart space via direct communication with the smart space or via retrieving information regarding the smart space from the Internet responsive to receiving identity related information regarding the smart space.

In an example embodiment, an apparatus for performing the method of FIG. 5 above may comprise a processor (e.g., the processor 70) configured to perform some or each of the operations (100-120) described above. The processor may, for example, be configured to perform the operations (100-120) by performing hardware implemented logical functions, executing stored instructions, or executing algorithms for performing each of the operations. Alternatively, the apparatus may comprise means for performing each of the operations described above. In this regard, according to an example embodiment, examples of means for performing operations 100-120 may comprise, for example, the processor 70, or respective ones of the session module 80, the provider requirement module 86, the property management module 88, and/or a device or circuit for executing instructions or executing an algorithm for processing information as described above.

An example of an apparatus according to an example embodiment may include at least one processor and at least one memory including computer program code. The at least one memory and the computer program code may be configured to, with the at least one processor, cause the apparatus to perform the operations 100-120 (with or without the modifications described above).

An example of a computer program product according to an example embodiment may include at least one computer-readable storage medium having computer-executable program code portions stored therein. The computer-executable program code portions may include program code instructions for performing operation 100-120 (with or without the modifications described above).

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A method comprising:
receiving vocabulary independent property information indicative of a property request and corresponding setting information of an application associated with a device capable of communication with a network communication environment;
determining capabilities of the network communication environment relative to the received property information; and
enabling generation of a selected scan function having selected scan parameters based at least in part on the determined capabilities and the property information.

2. The method of claim 1, further comprising selecting a particular scan technology.

3. The method of claim 2, wherein selecting the particular scan technology comprises selecting the particular scan technology based on current requirements weighing various options.

4. The method of claim 1, wherein enabling generation of the selected scan function comprises selecting a scan wave from a list of scan functions and applying scan parameters including a selectable frequency value or a selectable amplitude value to the selected scan wave.

5. The method of claim 1, wherein enabling generation of the selected scan function comprises selecting the amplitude value based on proximity of the device with respect to range or boundary information associated with the network communication environment.

6. The method of claim 1, wherein the network communication environment is a smart space.

7. The method of claim 1, wherein determining capabilities of the network communication environment comprises providing a translation between vocabulary associated with describing the property information by the device and a vocabulary associated with an ontology employed by the network communication environment for describing available properties.

8. The method of claim 1, wherein determining capabilities of the network communication environment comprises determining characteristics of a smart space via direct communication with the smart space.

9. The method of claim 1, wherein determining capabilities of the network communication environment comprises determining characteristics of a smart space via retrieving information regarding the smart space from the Internet responsive to receiving identity related information regarding the smart space.

10. An apparatus comprising at least one processor and at least one memory including computer program code, the at least one memory and the computer program code configured to, with the at least one processor, cause the apparatus at least to:
receive vocabulary independent property information indicative of a property request and corresponding setting information of an application associated with a device capable of communication with a network communication environment;
determine capabilities of the network communication environment relative to the received property information; and
enable generation of a selected scan function having selected scan parameters based at least in part on the determined capabilities and the property information.

11. The apparatus of claim 10, wherein the at least one memory and the computer program code are further configured to, with the at least one processor, cause the apparatus to select a particular scan technology.

12. The apparatus of claim 11, wherein the at least one memory and the computer program code are configured to, with the at least one processor, cause the apparatus to select the particular scan technology by selecting the particular scan technology based on current requirements weighing various options.

13. The apparatus of claim 10, wherein the at least one memory and the computer program code are configured to, with the at least one processor, cause the apparatus to enable generation of the selected scan function by selecting a scan wave from a list of scan functions and applying scan parameters including a selectable frequency value or a selectable amplitude value to the selected scan wave.

14. The apparatus of claim 10, wherein the at least one memory and the computer program code are configured to, with the at least one processor, cause the apparatus to enable generation of the selected scan function by selecting the amplitude value based on proximity of the device with respect to range or boundary information associated with the network communication environment.

15. The apparatus of claim 10, wherein the network communication environment is a smart space.

16. The apparatus of claim 10, wherein the at least one memory and the computer program code are configured to, with the at least one processor, cause the apparatus to determine capabilities of the network communication environment by providing a translation between vocabulary associated with describing the property information by the device and a vocabulary associated with an ontology employed by the network communication environment for describing available properties.

17. The apparatus of claim 10, wherein the at least one memory and the computer program code are configured to, with the at least one processor, cause the apparatus to determine capabilities of the network communication environment by determining characteristics of a smart space via direct communication with the smart space.

18. The apparatus of claim 10, wherein the at least one memory and the computer program code are configured to, with the at least one processor, cause the apparatus to determine capabilities of the network communication environment comprises determining characteristics of a smart space via retrieving information regarding the smart space from the Internet responsive to receiving identity related information regarding the smart space.

19. The apparatus of claim 10, wherein the apparatus is a mobile terminal and further comprises user interface circuitry configured to facilitate user control of at least some functions of the mobile terminal.

20. A computer program product comprising at least one computer-readable storage medium having computer-executable program code instructions stored therein, the computer-executable program code instructions including program code instructions to:
receive vocabulary independent property information indicative of a property request and corresponding setting information of an application associated with a device capable of communication with a network communication environment;
determine capabilities of the network communication environment relative to the received property information; and
enable generation of a selected scan function having selected scan parameters based at least in part on the determined capabilities and the property information.
